(19) United States
(12) Patent Application Publication
(10) Pub. No.: US 2019/0248215 A1
(43) Pub. Date: Aug. 15, 2019

(54) AUTOMOTIVE AIR HORIZONTAL AIMING VIA POWERED OVAL SHAPE VANES

(71) Applicant: NIO NEXTEV LIMITED, Central (HK)

(72) Inventors: Ren Ren, San Jose, CA (US); Padmanabhan Kumar, Fremont, CA (US); Ming Fung Wong, San Jose, CA (US); Matthew S. Filipkowski, Pleasanton, CA (US)

(21) Appl. No.: 15/898,077

(22) Filed: Feb. 15, 2018

(51) Int. Cl. B60H 1/34

(52) U.S. Cl. CPC B60H 1/3421; B60H 2001/3471

(57) ABSTRACT

An air vent achieves selective horizontal aiming of air flowing through the air vent by rotating a shaft that extends across the air vent and to which a plurality of vanes are fixedly attached. The vanes are mounted to the shaft at an angle, such that rotation of the shaft changes the angle of the vanes relative to the air flowing through the air vent. Each vane is a cylindrical section and has a circular perimeter when viewed along the axis of the shaft.

### FIELD

The present disclosure is generally directed to vehicle systems, and more particularly to vehicle ventilation systems.

### BACKGROUND

Heating, ventilation, and cooling (“HVAC”) systems have long been included in automobiles, whether as standard or optional equipment. Such systems typically comprise an HVAC module, which receives air, conditions the air as necessary (whether by heating or cooling, although in some instances no conditioning is needed or effected), mixes the air as necessary (e.g., mixes cooled air with fresh air or warm air with fresh air to achieve a desired air temperature), and blows the air through one or more ducts to one or more vents in the passenger cabin of the vehicle. HVAC modules thus selectively provide air, for example, to dashboard-mounted or dash-level vents, ceiling and sidewall mounted vents, floor-mounted or foot-level vents, and defrosting vents. Conventionally, automotive air vents may be manually adjusted to blow air in different horizontal directions by turning hinged vertical vanes toward the left or right.

### BRIEF DESCRIPTION OF THE DRAWINGS

FIG. 1 shows a vehicle in accordance with embodiments of the present disclosure;

FIG. 2 shows a passenger compartment of a vehicle such as the vehicle shown in FIG. 1 in accordance with embodiments of the present disclosure;

FIG. 3 shows a front view of an air vent in a first orientation according to one embodiment of the present disclosure;

FIG. 4 shows a front view of the air vent of FIG. 3 in a second orientation; and

FIG. 5 shows a perspective view of the air vent of FIG. 3 in the second orientation;

FIG. 6 shows a perspective view of a vane assembly according to an embodiment of the present disclosure;

FIG. 7 shows a side elevation view of the vane assembly of FIG. 6;

FIG. 8 shows a perspective view of a portion of an air vent according to one embodiment of the present disclosure;

FIG. 9 shows a perspective view of a portion of an air vent according to another embodiment of the present disclosure;

FIG. 10 shows a perspective view of an air vent according to another embodiment of the present disclosure, with the top removed for purposes of illustration and description;

FIG. 11 shows another perspective view of the air vent of FIG. 11;

FIG. 12 shows a front elevation view of the air vent of FIG. 11; and

FIG. 13 shows a top plan view of the air vent of FIG. 11.

### DETAILED DESCRIPTION

Embodiments of the present disclosure will be described in connection with a vehicle, and more particularly with respect to an automobile. However, for the avoidance of doubt, the present disclosure encompasses the use of the aspects described herein in vehicles other than automobiles.

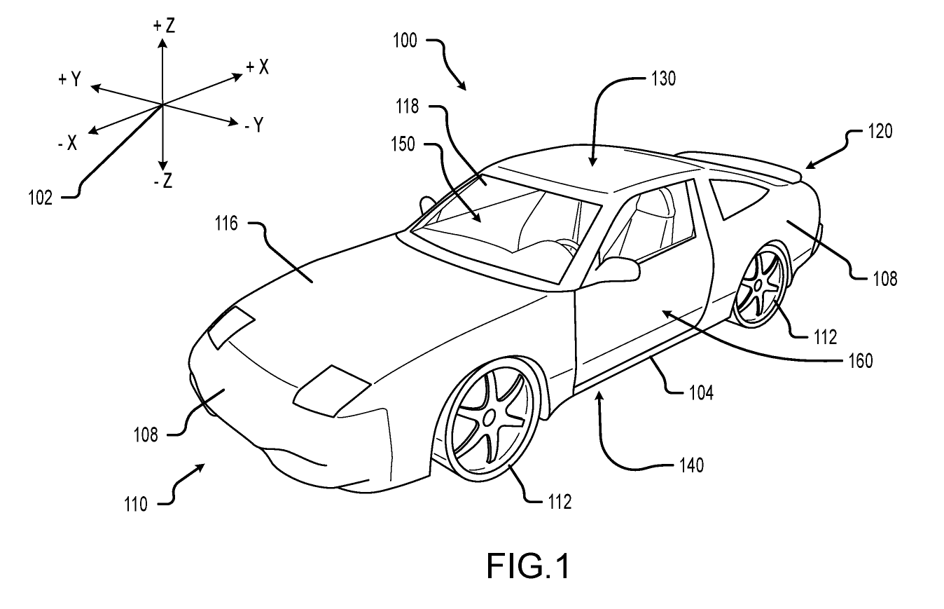

FIG. 1 shows a perspective view of a vehicle 100 in accordance with embodiments of the present disclosure. The vehicle 100 comprises a vehicle front 110, vehicle aft 120, vehicle roof 130, at least one vehicle side 160, a vehicle undercarriage 140, and a vehicle interior 150. The vehicle 100 may include a frame 104, one or more body panels 108 mounted or affixed thereto, and a windshield 118. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Coordinate system 102 is provided for added clarity in referencing relative locations in the vehicle 100. In this detailed description, an object is forward of another object or component if the object is located in the −X direction relative to the other object or component. Conversely, an object is rearward of another object or component if the object is located in the +X direction relative to the other object or component.

The vehicle 100 may be, by way of example only, an electric vehicle or a gas-powered vehicle. Where the vehicle 100 is an electric vehicle, the vehicle 100 may comprise one or more electric motors powered by electricity from an on-board battery pack. The electric motors may, for example, be mounted near or adjacent an axis or axle of each wheel 112 of the vehicle, and the battery pack may be mounted on the vehicle undercarriage 140. In such embodiments, the front compartment of the vehicle, referring to the space located under the vehicle hood 116, may be a storage or trunk space. Where the vehicle 100 is a gas-powered vehicle, the vehicle 100 may comprise a gas-powered engine and associated components in the front compartment (under the vehicle hood 116), which engine may be configured to drive either or both of the front wheels 112 and the rear wheels 112. In some embodiments where the vehicle 100 is gas-powered, the gas-powered engine and associated components may be located in a rear compartment of the vehicle 100, leaving the front compartment available for storage or trunk space or for other uses. In some embodiments, the vehicle 100 may be, in addition to a battery-powered electric vehicle and a gas-powered vehicle, a hybrid electric vehicle, a diesel-powered vehicle, or a fuel cell vehicle.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, buses, automobiles, trains, railed conveyances, boats, ships, marine conveyances, submarine conveyances, airplanes, space craft, flying machines, human-powered conveyances, and the like.

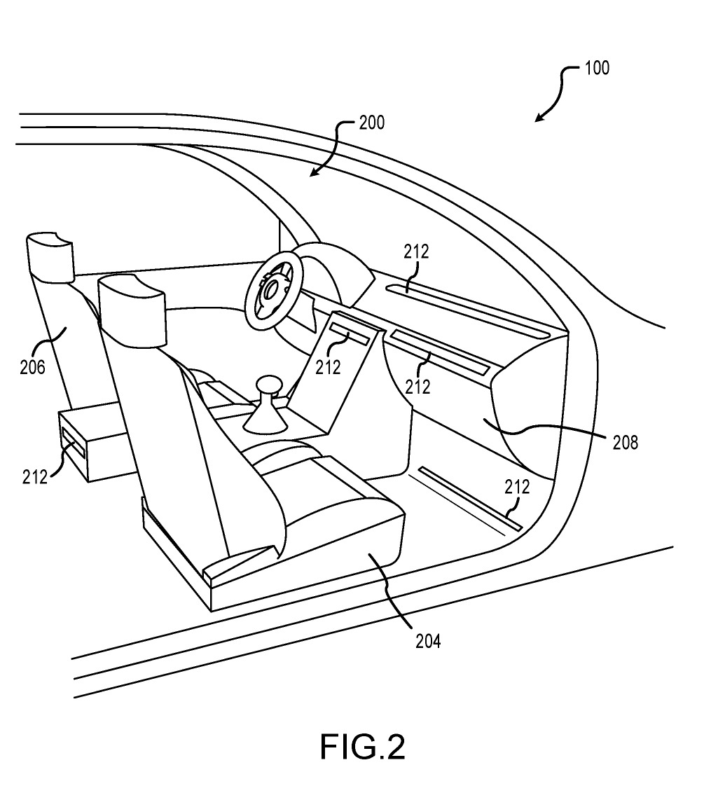

Referring now to FIG. 2, a vehicle passenger cabin 200 of a vehicle 100 according to embodiments of the present disclosure includes a passenger seat 204, a driver seat 206, and a dashboard or instrument panel or dash panel (all of which terms may be used interchangeably herein) 208. The dashboard may include one or more air registers or vents 212, through which heated, cooled, or unconditioned air may be introduced into the passenger compartment for climate control and ventilation purposes. The air vents 212 are connected to one or more air ducts (not shown in FIG. 2) that channel fresh or recirculated air from an HVAC module (not shown in FIG. 2) of the vehicle 100, as appropriate, to the air vents 212 for introduction into the passenger cabin 200. One or more of the air vents 212 may be positioned adjacent a windshield of the vehicle 100 for defrost purposes. Others of the air vents 212 may be positioned in the dashboard 208, for supplying air to the passenger cabin 200 at or near the head and/or torso of the front occupants of the passenger cabin 200. In vehicles 100 comprising more than one row of seats, one or more air vents 212 may be positioned immediately in front of or in close proximity to each row of seats so as to supply air to the occupant(s) of each row of seats. For example, an air vent 212 may be positioned behind a first row of seats for supplying air to the occupants of a second row of seats positioned behind the first row of seats. Still others of the air vents 212 may be positioned at or near the floor of the passenger cabin 200, for supplying air to the passenger cabin 200 at or near the feet of the occupants of the passenger cabin 200. Any number of air vents 212 may be included in the passenger cabin 200. Further, in some embodiments, air vents 212 may be positioned at or near the sides of the dashboard 208 for defrosting one or more side windows of the vehicle 100; and in or near the ceiling of the vehicle 100 for discharging air onto occupants of the vehicle 100 from above.

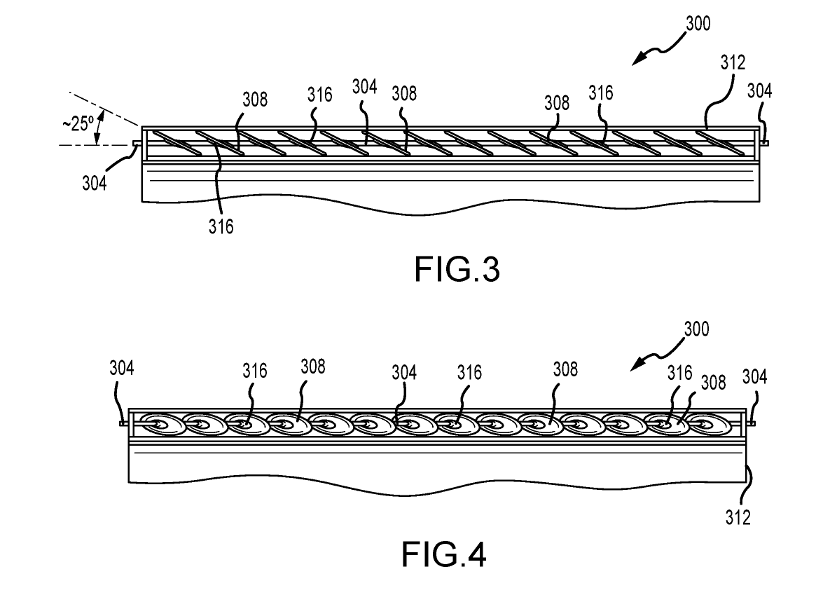

Referring now to FIG. 3, an air vent 300 according to one embodiment of the present disclosure comprises a duct or housing 312 that opens into a passenger cabin 200 such as that depicted in FIG. 2. Near the open end of the duct 312, the duct 312 supports an axle or shaft 304 that extends across the width of the duct 312, from one side of the duct 312 to the other. A plurality of vanes 308 are secured at regular intervals to the axle or shaft 304 using collets 316. The vanes 308 and the collets 316 may be integrally formed, or they may be formed separately and subsequently joined together. Similarly, the collets 316 and the axle 304 may be integrally formed, or they may be formed separately and subsequently joined together. In some embodiments, each of the axle 304, the vanes 308, and the collets 316 is separately formed, and in other embodiments, the axle 304, the vanes 308, and the collets 316 are integrally formed as a single piece. In still other embodiments, the vanes 308 are attached directly to (or formed integrally with) the axle 304, without the use of any collets 316.

Although the axle 304 is depicted in FIG. 3 as a single continuous rod to which the collets 316 and vanes 308 are affixed, in some embodiments the axle 304 is comprised of multiple sections, each section connecting one vane 308/collet 316 to another vane 308/collet 316. In such embodiments, the collets 316 connect sequential sections of the axle 308.

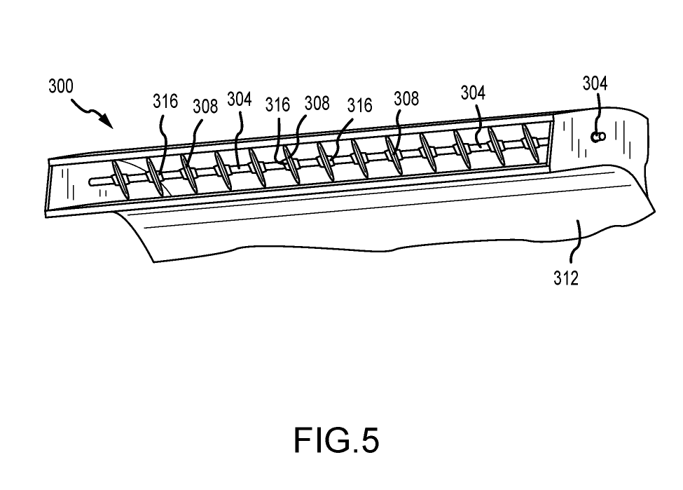

The vanes 308 are thin or substantially flat in a first dimension, and substantially elliptical in a second dimension perpendicular to the first dimension. In the second dimension, each vane 308 may define a cylindrical section or conical section. For example, FIG. 3 shows the air vent 300 in a first orientation, in which the axle 304 is rotated such that the vanes 308 appear substantially flat. FIG. 4, on the other hand, shows the air vent 300 in a second orientation, in which the axle 304 is rotated such that the vanes 308 appear substantially elliptical. FIG. 5 shows the air vent 300 in the same orientation as FIG. 4, but from a right-of-center perspective in which the vanes 308 again appear substantially flat. The vanes 308 are mounted to the axle or shaft 304 at an angle of approximately 25°, although in other embodiments the vanes 308 may be mounted to the axle or shaft 304 at one or more other angles.

As evident from FIGS. 3-5, rotation of the axle 304 causes the vanes 308 to rotate. Further, rotation of the vanes 308 causes the vanes 308 to direct air flowing out of the opening of the duct 312 in different horizontal directions. In FIG. 3, for example, the vanes 308 are rotated so as to direct air flowing through the opening of the duct 312 straight ahead. In FIG. 4, the vanes 308 have been rotated such that the vanes 308 channel the air to the right of the air vent 300. Thus, from the straight-ahead view of FIG. 4, the opening of the duct 300 has been substantially blocked by the vanes 308, but from the right-of-center view of FIG. 5, the vanes 308 present no obstacle to the flow of air. Although not shown, further rotation of the axle 304 will cause the vanes 308 to appear as a mirror image to FIGS. 4 and 5, and to cause air to flow toward the left side of the duct 312.

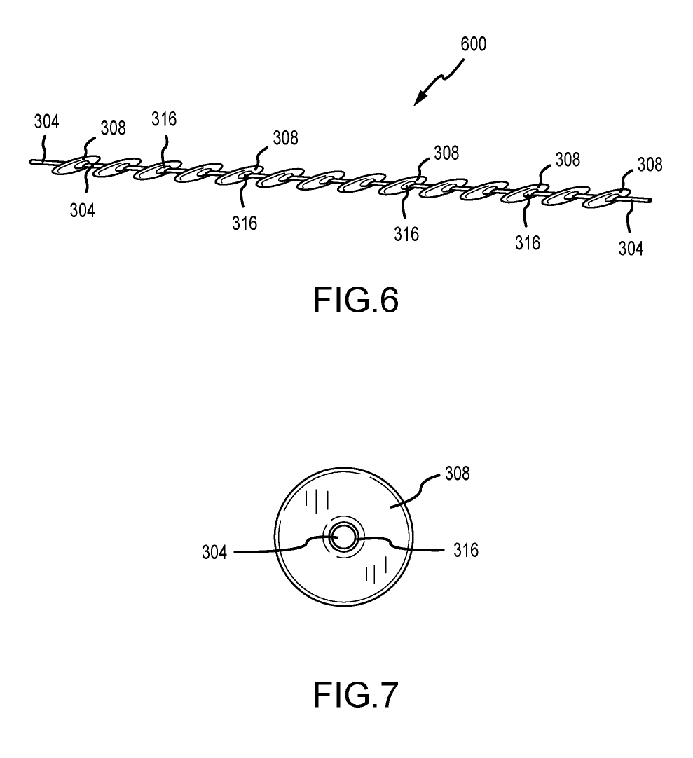

FIG. 6 shows a vane assembly 600 removed from any duct (such as the duct 312). Consistent with the description of the air vent 300 in FIGS. 3 to 5, the vane assembly 600 comprises an axle 304, to which a plurality of vanes 308 are attached by a plurality of collets 316. As also described above, the vane assembly 600 may be manufactured as a single integral component, or as one or more separate components that are subsequently joined together. In some embodiments, the entirety of the vane assembly is formed of plastic, such as polyethylene terephthalate or high-density polyethylene. In some embodiments, some or all of the vane assembly may be formed of carbon fiber laminate or one or more other composite materials. In still other embodiments, the axle 304 and/or other portions of the vane assembly may be formed of metal, such as an aluminum alloy or steel.

Like the vanes 308 in FIG. 3, the vanes 308 of the vane assembly 600 are connected to (or formed on) the axle 304 at an angle of approximately 25°, which is an angle of 65° measured from a line perpendicular to the axle 304. As a result, the vane assembly 600 is configured to deflect air flowing out of an air vent 300 at angles ranging from 0° (e.g., straight ahead, with no deflection) to 65° (to the right or left, with full deflection). In other words, the vane assembly 600 has a maximum throw of 65°. Moreover, as shown in FIG. 7, the vanes 308 are shaped so as to be substantially circular when viewed along the axis of the axle 304. This substantially circular shape along the axis of the axle 304 allows the vane assembly 600 to rotate freely within a duct 312. The vane assembly 600 is configured to rotate along an axis that is perpendicular to the direction from which the throw is measured, which allows for clean packaging and, where desired, a narrow, long geometry. For example, the vane assembly 600 may be used in an air duct having an outlet with a rectangular cross-section, where the width of the outlet is greater than three times the height of the outlet, or greater than five times the height of the outlet, or greater than ten times the height of the outlet.

In some embodiments of the present disclosure, the vanes 308 may be secured to the axle 304 at an angle other than 25°, provided that the shape of the vanes 308 is adjusted to maintain a substantially circular perimeter as viewed along the axis of the axle 304. For example, the vanes 308 may be attached to the axle 304 at any angle between approximately 5° and approximately 85°. If the vanes 308 are attached to the axle 304 at an angle of 5°, each elliptical vane 308 must have a major axis substantially longer than the major axis of the vanes 308 depicted in FIGS. 3-7 so as to maintain a substantially circular shape along the axis of the axle 304. On the other hand, if the vanes 308 are attached to the axle 304 at an angle of 85°, each elliptical vane 308 must have a major axis substantially shorter than the major axis of the vanes 308 depicted in FIGS. 3-7 so as to maintain a substantially circular shape along the axis of the axle 304. Further, vanes 308 attached to an axle 304 at an angle of only 5° may need to be stiffened or connected to each other not just along the axle 304, but at one or more other points as well (for example, near the ends of the major axis), to prevent undesired deformation of the vanes 308 at the extremities thereof.

The angle between the vanes 308 and the axle 304 of the vane assembly 600 may be selected based on the particular application in which the vane assembly 600 may be used. For example, if a vane assembly 600 will be used in an air vent 300 positioned in the middle of a wide vehicle and intended to provide air across the entire width of the vehicle (e.g., to multiple occupants sitting abreast, or to defrost an entire windshield), then a lower angle between the vanes 308 and the axle 304 may be desirable to enhance the ability of the air vent to direct air from the center of the vehicle to the sides of the vehicle. On the other hand, if the air vent 300 extends directly in front of the entire area it is intended to reach, then a higher angle between the vanes 308 and the axle 304 may be desirable, as less deflection will be needed.

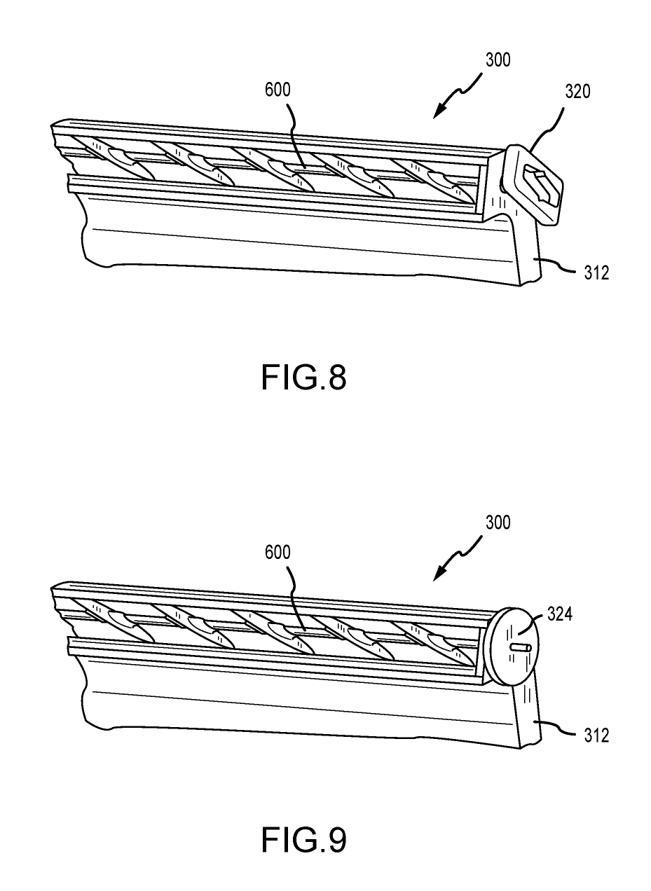

Referring now to FIGS. 8 and 9, a vane assembly 600 positioned within a duct 312 may be automatically controlled by coupling a motor (not shown) to the axle 304 using a motor coupling 320. The motor coupling 320 may have the shape shown in FIG. 8 or any other shape suitable for enabling a motor to selectively drive the axle 304, based on passenger compartment climate control settings. In some embodiments, the axle 304 may be, or comprise an extension of, a motor shaft. Enabling automatic control of the vane assembly 600 by operably attaching a motor thereto yields several benefits. First, the motor can continuously rotate the vane assembly 600, so as to sequentially direct air across the entire area serviced by the air vent 300. This contrasts with the manual air vent controls on current vehicles, which must be repositioned by an operator to change the direction of air flow. Second, because a single vent can be used to sequentially direct air across an entire area without operator involvement, fewer vents are needed, yielding important space and cost savings. Third, connecting the vane assembly 600 to a motor allows manual controls for the vane assembly 600 to be eliminated, which allows for improved aesthetics within the passenger cabin 200 or other space in which the air vent 300 is positioned.

A motor used to rotate the axle or shaft 304 may be, for example, any motor suitable for use in a vehicle. In some embodiments, the motor may be a DC motor. The motor may also be a 12-volt motor. The size and other characteristics of the motor may be selected, for example, based on the length of the axle 304, the ease of rotation of the axle 304, and the parameters of the electrical system of the vehicle in which the motor will be installed. In some embodiments, a single motor may be (permanently or detachably) coupled to a plurality of vane assemblies 600.

A vane assembly 600 positioned within a duct 312 may alternatively be manually rotatable (as in FIG. 9), such as via a wheel 324 fixedly secured to the axle 304 of the assembly 600 and positioned so as to be accessible to a vehicle occupant or other user of the air vent 300. In such embodiments, the size of the wheel 324 may depend on the distance between the axle 304 and the opening of the duct 312, with larger distances necessitating a larger wheel 324 and smaller distances permitting a smaller wheel 324. Manual, rather than automatic, controls may be desirable to reduce the complexity of a vehicle (e.g., by reducing the number of electrical components within the vehicle, and because coupling the vane assembly 600 to a motor also likely requires including an interface by which the motor can be controlled), and/or to avoid the expense of adding a motor (which expense may or may not be offset by savings to be gained where fewer vents are needed due to the availability of motor-driven vane assemblies that can continuously rotate a vane assembly 600 so as to provide air flow across a larger area than if the vane assembly 600 were manually adjusted to a single position and left in that position until further manual adjustment).

Although the vane assembly 600 illustrated in the Figures is shown with a certain number of vanes 308 and having a certain size, the present disclosure is not limited to identical vane assemblies. In particular, the number of vanes 308 included on a vane assembly 600 for a particular application will depend upon the width of the air vent 300 in which the vane assembly 600 is installed, as well as the size of the vanes 308 (which, in turn, will be determined at least in party by the angle at which the vanes 308 are installed on the axle 304). For example, larger vanes mounted to the axle 304 at angles closer to 5° will have a greater length in the direction parallel to the axle 304, such that fewer vanes 308 will fit within a given air vent 300. On the other hand, smaller vanes 308 mounted to the axle 304 at angles closer to 85° will have a shorter length in the axial direction than if the vanes 308 were mounted to the axle 304 at an angle closer to 5°, such that more vanes 308 will fit on the axle 304 within the given air vent 300.

Additionally, the height of air vents 300 in which a vane assembly 600 is installed may vary. To ensure that the vane assembly 600 is able to deflect air flow through a given air vent, the diameter of the substantially circular shape formed by the vanes 308 when viewed in the axial direction should be slightly less than the height of the air vent 300. In some embodiments, the vanes 308 may just touch the upper and lower walls of the duct 312 in which the vanes 308 are located, while in other embodiments, the vanes 308 may not quite touch the upper and lower walls of the duct 312. As will be apparent in light of this disclosure, if a substantial gap exists between the upper and lower edges of the vanes 308 and the upper and lower walls of the duct 312, respectively, then air flowing out of the duct 312 will be able to flow around the vane assembly 600, thus reducing or negating the effectiveness of the vane assembly 600.

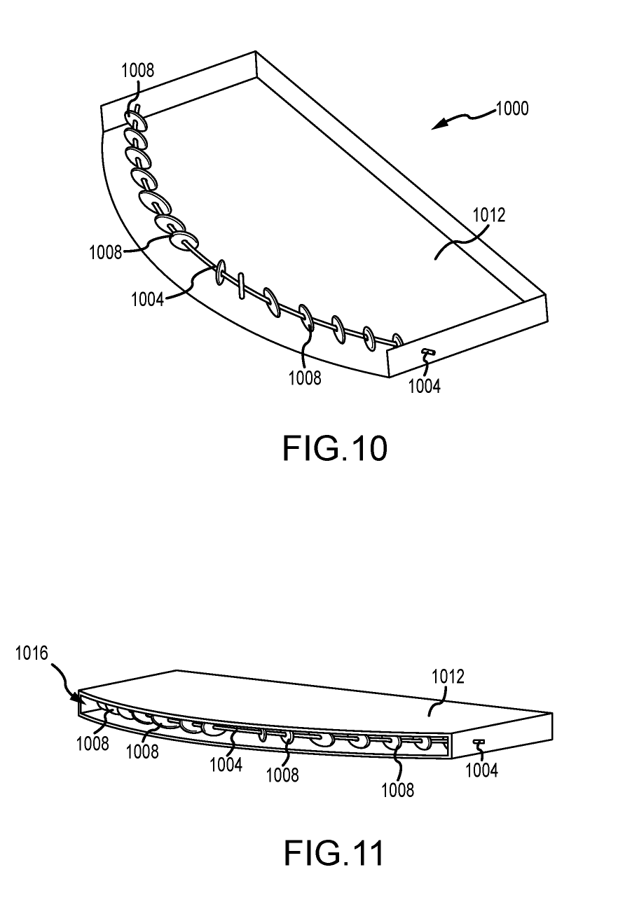

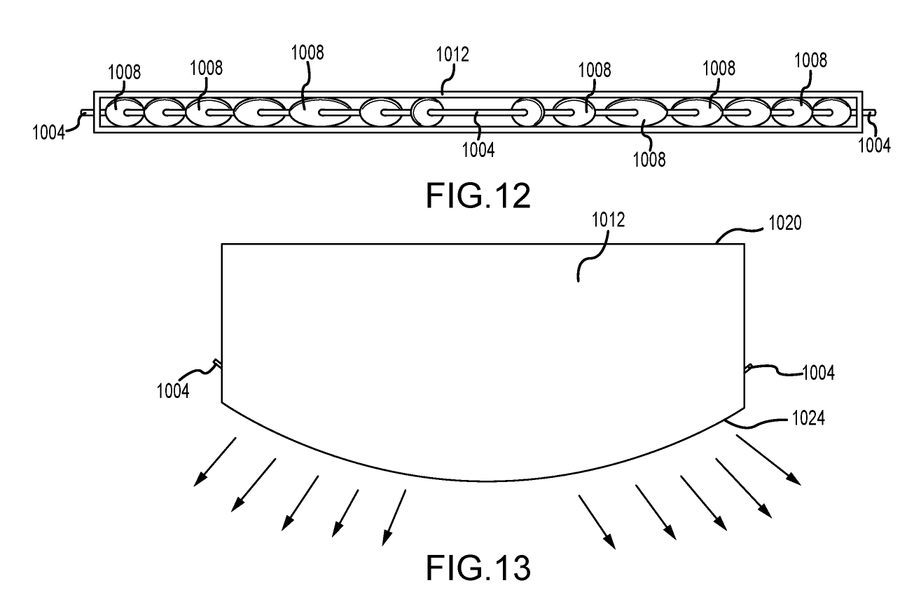

Referring now to FIGS. 10-13, an air vent 1000 according to another embodiment of the present disclosure comprises an air duct 1012 (shown in FIG. 10 with the top removed to facilitate description thereof) having a curved front 1024 defining an air outlet 1016. A flexible rod 1004 is rotatably supported by opposite sides of the duct 1012 adjacent the outlet 1016, in such a manner to give the flexible rod 1004 a curvature that is the same as or similar to the curvature of the outlet 1016 of the air duct 1012. A plurality of vanes 1008 are fixedly attached to the flexible rod 1004 at a plurality of angles. As the flexible rod 1004 is rotated, the vanes 1008 also rotate, thus changing the angle of the vanes relative to the air outlet 1016 and causing the vanes to channel the flowing air in different directions relative to the air outlet 1016.

With respect to FIG. 13 specifically, air enters the duct 1012 through a rear inlet 1020 (which, in some embodiments, may be attached directly to an HVAC module that blows air into the duct 1012), and exits the duct 1012 through the air outlet 1016 on the front 1024 of the duct 1012. The arrows in FIG. 13 illustrate the direction of air flowing out of the duct 1012 with the vanes 1008 and flexible rod 1004 in one orientation. Rotation of the flexible rod 1004 will cause the vanes 1008 to rotate, which in turn will change the direction of air flowing out of the outlet end of the duct 1012.

As may be appreciated based on the description of FIGS. 3-9, the vanes 1008 may be attached directly to (or integrally formed with) the flexible rod 1004, or the vanes 1008 may be attached to (or integrally formed with) a collet (similar to the collets 316), which in turn may be attached to (or integrally formed with) the flexible rod 1004. The vanes 1008 may be made of the same material as the flexible rod 1004, or the vanes 1008 may be made of a different material. In some embodiments, the vanes 1008 are stiff, in contrast to the flexibility of the flexible rod 1004.

The vanes 1008 of the air vent 1000 are not all identical. The shape of each vane 1008 is based on the angle at which each vane 1008 is attached to or otherwise extends from the flexible rod 1004. Thus, vanes 1008 extending from the flexible rod 1004 at angles closer to perpendicular to the flexible rod 1004 are more circular in shape (when viewed at a right angle to the plane in which the vane extends), while vanes 1008 extending from the flexible rod 1004 at angles that are closer to parallel to the flexible rod 1004 are more elliptical in shape (again, when viewed at a right angle to the plane in which the vane extends). When viewed along a line that is tangent to the axis of the flexible rod 1004 at the point of attachment of the vane 1008 to the flexible rod 1004, however, each of the vanes 1008 is circular, thus allowing the vanes 1008 to rotate together with the flexible rod 1004, without being obstructed by the top and bottom surfaces of the duct 1012.

Any number of vanes 1008 may be attached to the flexible rod 1004, provided that the number of vanes 1008 is not so great as to reduce airflow through the air duct 1012 by an undesirable amount, or to prevent rotation of the flexible rod 1004, and further provided that the number of vanes 1008 is not so few as to have an undesirably minimal effect on the direction of airflow from the outlet of the duct 1012. Additionally, the angles at which the vanes 1008 are attached to or otherwise extend from the flexible rod 1004 may be selected based on the desired coverage of the air vent 1000. If the air vent 1000 is intended to direct air across the entire width of a vehicle passenger compartment, then the vanes 1008 nearest the sides of the air duct 1012 may extend from the flexible rod 1004 at an angle that is almost perpendicular to the initial direction of flow through the air vent 1000, with each vane 1008 that is successively closer to the center of the duct 1012 angled closer to parallel with the initial direction of flow through the air vent 1000 than the preceding vane 1008. In this manner, the vanes 1008 channel the air outward from the duct 1012 as shown, for example, by the arrows in FIG. 13. By rotating the flexible rod 1004, the direction in which the vanes 1008 channel air flowing through the duct 1012 may be adjusted, so as to satisfy changing demands for desired direction of air flow.

Except as otherwise described above, the flexible rod 1004 may be the same as or similar to the axle 304, and the vanes 1008 may be the same as or similar to the vanes 308. The air vent 1000 may beneficially be used where increased horizontal air aiming coverage is desired, and/or where use of a duct 1012 having a curved outlet is desirable or necessary.

Although embodiments of the present disclosure are not limited to long, narrow air vents, the ability of present disclosure to be applied with a long, narrow air vent beneficially increases the options available to vehicle designers and other space planners, as traditionally shaped air vents—which can consume substantial space in a given area—may be replaced with long, narrow vents that may be locatable out of the way of other key vehicle components. Long, narrow air vents may be placed, for example, along an upper surface of a dashboard, or in a vehicle ceiling.

Additionally, in some embodiments, the top and bottom of an air duct 312 may partially curve around the circular cross-section (along the axis of the axle or shaft 304) of a vane assembly 600 according to embodiments of the present disclosure. Such curvature may be included for aesthetic purposes (e.g., to reduce the amount of the vane assembly 600 that is visible from a passenger compartment), and/or to increase the exit velocity of air flowing through the duct.

Additionally, according to some embodiments of the present disclosure, a vane assembly 600 may be mounted vertically in tall, narrow air vent, which may be positioned, for example, on an interior column or pillar of a vehicle. In such embodiments, rotation of the vane assembly 600 within the air vent directs the air out of the air vent in directions ranging from upward to downward.

The features of the various embodiments described herein are not intended to be mutually exclusive. Instead, features and aspects of one embodiment may be combined with features or aspects of another embodiment. Additionally, the description of a particular element with respect to one embodiment may apply to the use of that particular element in another embodiment, regardless of whether the description is repeated in connection with the use of the particular element in the other embodiment.

Examples provided herein are intended to be illustrative and non-limiting. Thus, any example or set of examples provided to illustrate one or more aspects of the present disclosure should not be considered to comprise the entire set of possible embodiments of the aspect in question. Examples may be identified by the use of such language as “for example,” “such as,” “by way of example,” “e.g.,” and other language commonly understood to indicate that what follows is an example.

The systems and methods of this disclosure have been described in relation to the air vents positioned in a vehicle. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Embodiments include an air vent, comprising: an air duct comprising a first side, a second side, a top, and a bottom, the air duct comprising an air outlet; a central shaft extending across the air duct from the first side to the second side, the central shaft rotatably attached to the first side and the second side near the air outlet; and a plurality of vanes fixedly secured to the central shaft at an angle, each vane defining a plane that intersects the central shaft at the angle; wherein each vane defines a conic section in the plane defined by the vane, and further wherein each vane has a circular perimeter relative to an axis of rotation of the vane.

Aspects of the above air vent include: a plurality of collets, each of the plurality of collets connecting one of the plurality of vanes to the central shaft; wherein the air outlet is rectangular in cross-section and has a height H between the top and the bottom of the air duct, and a width greater than 5H between the first side and the second side of the air duct; wherein one end of the central shaft extends through one of the first side and the second side; wherein a control wheel is fixedly attached to the one end, the control wheel manually operable to rotate the central shaft within the air duct; wherein a motor is coupled to the one end, the motor configured to selectively rotate the central shaft; wherein the air vent is positioned within a passenger compartment of a vehicle, and the motor is configured to selectively rotate the central shaft based on vehicle climate control settings; wherein each of the plurality of vanes is fixedly secured to the central shaft at a common angle; wherein the plurality of vanes is fixedly secured to the central shaft at a plurality of angles; and wherein the central shaft is flexible, and further wherein the central shaft is rotatably secured in a curved position by the first side and the second side.

Embodiments also include a vehicle comprising: a passenger compartment; a climate control system comprising at least one air duct extending to the passenger compartment, the air duct comprising a top surface, a bottom surface, a first sidewall, and a second sidewall, the air duct further comprising an outlet for discharging air into the passenger compartment; a shaft rotatably positioned within the air duct adjacent the outlet; and a plurality of vanes mounted to the shaft at an angle other than a right angle, each of the plurality of vanes shaped as a cylindrical section and having a circular perimeter when viewed along an axis of the shaft.

Aspects of the above vehicle include: wherein the shaft is flexible and the plurality of vanes are mounted to the shaft at a plurality of angles; wherein rotation of the shaft changes the orientation of the plurality of vanes relative to air flowing through the air duct; wherein rotation of the shaft to a first orientation causes the plurality of vanes to direct air through the outlet in a first direction, and rotation of the shaft to a second orientation different than the first orientation causes the plurality of vanes to direct air through the outlet in a second direction different than the first direction; wherein the outlet has a rectangular perimeter with a height less than or equal to one-fifth of a width; and wherein the shaft further comprises a motor coupling.

Embodiments further include an air vent comprising: an air duct having a fixed height and width; a shaft extending across the width of the air duct; and a plurality of vanes, each shaped as a cylindrical section and each affixed to the shaft at an angle greater than or equal to five degrees and less than or equal to eighty-five degrees; wherein a first distance, measured perpendicular to the shaft, from the shaft to any point on an outer perimeter of any one of the plurality of vanes is equal to a second distance, measured perpendicular to the shaft, from the shaft to any point on an outer perimeter of any other one of the plurality of vanes.

Aspects of the above air vent include: wherein the shaft is rotatably mounted across the width of the air duct; wherein the shaft comprises a motor coupling; and wherein the shaft is flexible and the plurality of vanes are affixed to the shaft at a plurality of angles.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. An air vent, comprising:
an air duct comprising a first side, a second side, a top, and a bottom, the air duct comprising an air outlet;
a central shaft extending across the air duct from the first side to the second side, the central shaft rotatably attached to the first side and the second side near the air outlet; and
a plurality of vanes fixedly secured to the central shaft at an angle, each vane of the plurality of vanes defining a plane that intersects the central shaft at the angle;
wherein each vane of the plurality of vanes defines a conical section in the plane defined by the respective vane, and further wherein each vane of the plurality of vanes has a circular perimeter relative to an axis of rotation of the respective vane.

2. The air vent of claim 1, further comprising a plurality of collets, each of the plurality of collets connecting a corresponding one of the plurality of vanes to the central shaft.

3. The air vent of claim 1, wherein the air outlet is rectangular in cross-section and has a height H between the top and the bottom of the air duct, and a width greater than 5H between the first side and the second side of the air duct.

4. The air vent of claim 1, wherein one end of the central shaft extends through one of the first side and the second side.

5. The air vent of claim 4, wherein a control wheel is fixedly attached to the one end, the control wheel manually operable to rotate the central shaft within the air duct.

6. The air vent of claim 4, wherein a motor is coupled to the one end, the motor configured to selectively rotate the central shaft.

7. The air vent of claim 6, wherein the air vent is positioned within a passenger compartment of a vehicle, and the motor is configured to selectively rotate the central shaft based on vehicle climate control settings.

8. The air vent of claim 1, wherein each of the plurality of vanes is fixedly secured to the central shaft at a common angle.

9. The air vent of claim 1, wherein the plurality of vanes is fixedly secured to the central shaft at a plurality of angles.

10. The air vent of claim 1, wherein the central shaft is flexible, and further wherein the central shaft is rotatably secured in a curved position by the first side and the second side.

11. A vehicle comprising:
a passenger compartment;
a climate control system comprising at least one air duct extending to the passenger compartment, the air duct comprising a top surface, a bottom surface, a first sidewall, and a second sidewall, the air duct further comprising an outlet for discharging air into the passenger compartment;
a shaft rotatably positioned within the air duct adjacent the outlet; and
a plurality of vanes mounted to the shaft at an angle other than a right angle, each of the plurality of vanes shaped as a cylindrical section and having a circular perimeter when viewed along an axis of the shaft.

12. The vehicle of claim 11, wherein the shaft is flexible and the plurality of vanes are mounted to the shaft at a plurality of angles.

13. The vehicle of claim 11, wherein rotation of the shaft changes the orientation of the plurality of vanes relative to air flowing through the air duct.

14. The vehicle of claim 11, wherein rotation of the shaft to a first orientation causes the plurality of vanes to direct air through the outlet in a first direction, and rotation of the shaft to a second orientation different than the first orientation causes the plurality of vanes to direct air through the outlet in a second direction different than the first direction.

15. The vehicle of claim 11, wherein the outlet has a rectangular perimeter with a height less than or equal to one-fifth of a width.

16. The vehicle of claim 11, wherein the shaft further comprises a motor coupling.

17. An air vent comprising:
an air duct having a fixed height and width;
a shaft extending across the width of the air duct; and
a plurality of vanes, each of the plurality of vanes being shaped as a cylindrical section and each of the plurality of vanes being affixed to the shaft at an angle greater than or equal to five degrees and less than or equal to eighty-five degrees;
wherein a first distance, measured perpendicular to the shaft, from the shaft to any point on an outer perimeter of any one of the plurality of vanes is equal to a second distance, measured perpendicular to the shaft, from the shaft to any point on an outer perimeter of any other one of the plurality of vanes.

18. The air vent of claim 17, wherein the shaft is rotatably mounted across the width of the air duct.

19. The air vent of claim 18, wherein the shaft comprises a motor coupling.

20. The air vent of claim 17, wherein the shaft is flexible and the plurality of vanes are affixed to the shaft at a plurality of angles.
